(19) United States
(12) Patent Application Publication
(10) Pub. No.: US 2013/0148243 A1
(43) Pub. Date: Jun. 13, 2013

(54) ESD PROTECTING CIRCUIT AND SEMICONDUCTOR DEVICE INCLUDING THE SAME

(71) Applicant: Sony Corporation, Tokyo (JP)

(72) Inventor: Shimpei Tsujikawa, Tokyo (JP)

(73) Assignee: SONY CORPORATION, Tokyo (JP)

(21) Appl. No.: 13/678,632

(22) Filed: Nov. 16, 2012

(30) Foreign Application Priority Data
Dec. 7, 2011 (JP) 2011-267545

(51) Int. Cl. H02H 9/04

(52) U.S. Cl. CPC H02H 9/044
USPC 361/56

(57) ABSTRACT

An electrostatic discharge protecting circuit includes a trigger circuit and a protecting transistor. The trigger circuit includes a capacitive element and a resistive element and connected between two power source lines. The protecting transistor is connected in parallel with the trigger circuit and has a control electrode connected to an output terminal of the trigger circuit. The trigger circuit has an MIS capacitor as the capacitive element, and the resistive element is composed of an upper electrode of the MIS capacitor. In addition, a semiconductor device has the above-described electrostatic discharge protecting circuit protecting an internal circuit connected between two power source lines.

### BACKGROUND

The present disclosure relates to an Electrostatic Discharge (ESD) protecting circuit for protecting an internal circuit from sudden rise of a voltage due to ESD (hereinafter referred to as “a high-voltage pulse”) to an external connection terminal, and a semiconductor device including the same.

In general, in semiconductor integrated circuits such as a Large Scale Integrated Circuit (LSI), an ESD protecting circuit is provided for the purpose of preventing an internal circuit from being destroyed when a high-voltage pulse is generated in an external connection terminal due to ESD. For example, an ESD protecting circuit, called an RC triggered MOS (Metal Oxide Semiconductor), for triggering a protecting MOS transistor by using both of a resistive element R and a capacitive element C is described in Non-Patent Document 1 of C. A. Torres et al.; “Modular, Portable, and Easily Simulated ESD Protection Networks for Advanced CMOS Technologies,” Electrical Overstress/Electrostatic Discharge Symposium, September 11 to 13. Symposium Proceedings, p. 81 to 94, FIG. 1.

### SUMMARY

However, in the existing RC triggered MOS type ESD (electrostatic discharge) protecting circuit, the resistive element R and the capacitive element C are provided separately from each other. Thus, a total occupied area of the resistive element R and the capacitive element C becomes large.

It is therefore desirable to provide an ESD protecting circuit in which a total occupied area of a resistive element and a capacitive element can be reduced, and a semiconductor device including the same.

In order to attain the desire described above, according to an embodiment of the present disclosure, there is provided an electrostatic discharge protecting circuit including: a trigger circuit including a capacitive element and a resistive element and connected between two power source lines; and a protecting transistor connected in parallel with the trigger circuit and having a control electrode connected to an output terminal of the trigger circuit, in which the trigger circuit has an MIS capacitor as the capacitive element, and the resistive element is composed of an upper electrode of the MIS capacitor.

According to another embodiment of the present disclosure, there is provided a semiconductor device including an electrostatic discharge protecting circuit protecting an internal circuit connected between two power source lines. The electrostatic discharge protecting circuit includes: a trigger circuit including a capacitive element and a resistive element and connected between the two power source lines; and a protecting transistor connected in parallel with the trigger circuit and having a control electrode connected to an output terminal of the trigger circuit. The trigger circuit has an MIS capacitor as the capacitive element, and the resistive element is composed of an upper electrode of the MIS capacitor.

In the electrostatic discharge protecting circuit according to the embodiment of the present disclosure or in the semiconductor device according to another embodiment of the present disclosure, when a positive high-voltage pulse due to the electrostatic discharge is applied to one of the two power source lines, the protecting transistor is turned ON (becomes a conduction state) by the trigger circuit including the capacitive element and the resistive element. As a result, the high voltage generated in one of the two power source lines is made to escape to the other power source line with the assistance of a channel current. As a result, the internal circuit is protected from the high voltage.

In this case, the trigger circuit has the MIS capacitor as the capacitive element, and the resistive element is composed of the upper electrode of the MIS capacitor. Therefore, the occupied area of the capacitive element and the resistive element is reduced as compared with the case where the capacitive element and the resistive element are provided separately from each other as with the related art.

As set forth hereinabove, according to an embodiment of the present disclosure, in the trigger circuit of the ESD protecting circuit, the MIS capacitor is provided as the capacitive element, and the resistive element is composed of the upper electrode of the MIS capacitor. Therefore, the capacitive element and the resistive element of the trigger circuit are integrated with each other, thereby making it possible to reduce the occupied area of the capacitive element and the resistive element.

### BRIEF DESCRIPTION OF THE DRAWINGS

FIG. 1 is a circuit diagram showing a configuration of a semiconductor device, including an electrostatic discharge (ESD) protecting circuit, according to a first embodiment of the present disclosure;

FIG. 2 is a graph representing discharge current characteristics of the ESD protecting circuit in the semiconductor device according to the first embodiment of the present disclosure shown in FIG. 1;

FIG. 3 is a perspective element showing a construction of a capacitive element-resistive element integrated element (R-C integrated element) in the ESD protecting circuit shown in FIG. 1;

FIG. 4 is a top plan view showing a structure of the RC integrated element shown in FIG. 3;

FIG. 5 is an equivalent circuit diagram showing a configuration of the RC integrated element shown in FIG. 3;

FIG. 6 is a circuit diagram showing a configuration of the ESD protecting circuit including the RC integrated element shown in FIG. 3; and

FIG. 7 is a graph representing a transient response of the ESD protecting circuit shown in FIG. 6.

### DETAILED DESCRIPTION OF THE PREFERRED EMBODIMENTS

Embodiments of the present disclosure will be described in detail hereinafter with reference to the accompanying drawings.

### 1. First Embodiment

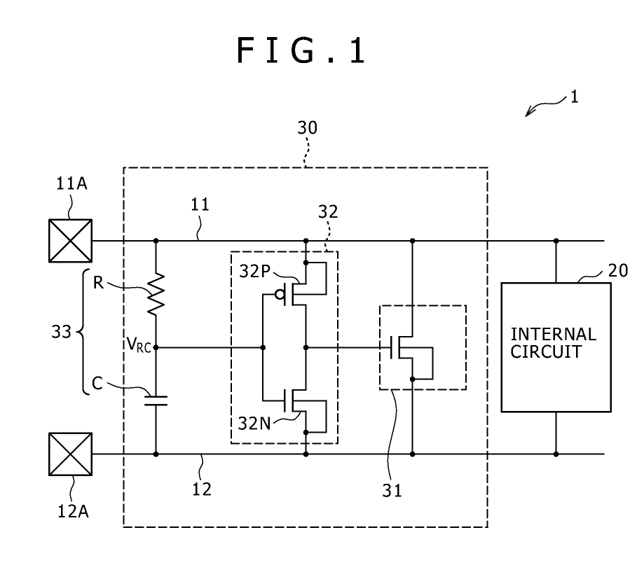

FIG. 1 is a circuit diagram showing a configuration of a semiconductor device according to a first embodiment of the present disclosure. The semiconductor device 1 is such that an internal circuit (protected circuit) 20 and an ESD (Electrostatic Discharge) protecting circuit 30 are connected in parallel with each other between a power source wiring 11 and a grounding wiring 12. The ESD protecting circuit 30 protects the internal circuit 20 from a high-voltage pulse due to electrostatic discharge. Thus, the ESD protecting circuit 30 includes a protecting MOS (Metal Oxide Semiconductor) transistor 31, a CMOS (Complementary Metal Oxide Semiconductor) inverter circuit 32, and a trigger circuit 33 having a capacitive element C and a resistive element R. The ESD protecting circuit 30 is called an RC trigger MOS because as will be described later, both of the capacitive element C and the resistive element R trigger the protecting MOS transistor 31. Although in the figure, the CMOS inverter is shown as one stage, the CMOS inverter may be configured as plural odd stages such as three stages.

The power source wiring 11 is a power source voltage line to which a power source terminal 11A is connected. Also, the grounding wiring 12 is a reference voltage line to which a grounding terminal 12A is connected.

The protecting MOS transistor 31 is provided for causing a high-voltage due to the ESD to escape to the grounding wiring 12. Thus, the protecting MOS transistor 31 is connected in parallel with the trigger circuit 33 between the power source wiring 11 and the grounding wiring 12. The protecting MOS transistor 31 is a transistor whose channel conductivity type is an n-type. A drain terminal of the protecting MOS transistor 31 is connected to the power source wiring 11, and a source terminal thereof is connected to the grounding wiring 12. A substrate region (including a p-type well region and the like) of the protecting MOS transistor 31 is electrically short-circuited with the source terminal thereof. However, although this configuration is preferable for a stable operation, this configuration is not essential to the semiconductor device of the present disclosure.

The CMOS inverter circuit 32 includes a PMOS transistor 32P and an NMOS transistor 32N which are connected in series with each other between the power source wiring 11 and the grounding wiring 12. A common gate terminal of the PMOS transistor 32P and the NMOS transistor 32N is connected to an inter-element node between the resistive element R and the capacitive element C. A common drain (an output terminal of the CMOS inverter circuit 32) of the PMOS transistor 32P and the NMOS transistor 32N is connected to a gate terminal (control electrode) of the protecting MOS transistor 31.

The trigger circuit 33 is an RC series circuit (detecting circuit) in which the resistive element R and the capacitive element C are connected in series with each other between the power source wiring 11 and the grounding wiring 12. The resistive element R and the capacitive element C are connected to the power source wiring 11 side and the grounding wiring 12 side, respectively. In the trigger circuit 33, a connection point between the resistive element R and the capacitive element C is connected to an input terminal of the CMOS inverter circuit 32.

An operation of the ESD protecting circuit 30 is as follows.

Firstly, since in a normal state in which no electrostatic discharge is generated, a resistance value of the capacitive element C is larger than that of the resistive element R, an electric potential V_{RC} developed at the connection point between the resistive element R and the capacitive element C becomes higher than a threshold voltage of the CMOS inverter circuit 32. Therefore, the NMOS transistor 32N of the CMOS inverter circuit 32 is turned ON and the PMOS transistor 32P of the CMOS inverter circuit 32 is turned OFF, so that the protecting MOS transistor 31 is turned OFF (non-conduction state).

When a positive high-voltage pulse due to the ESD is applied to the power source wiring 11, the electric potential V_{RC} developed at the connection point between the resistive element R and the capacitive element C rises later than the electric potential of the power source wiring 11 because the capacitive element C is charged with the electric charges. At this time, for a given period of time for which the electric potential V_{RC} is lower than the threshold voltage of the CMOS inverter circuit 32, the NMOS transistor 32N of the CMOS inverter circuit 32 is held in the OFF state and the PMOS transistor 32P of the CMOS inverter circuit 32 is held in the ON state. As a result, a voltage of the power source wiring 11 is applied to the gate terminal of the protecting MOS transistor 31, and for the given period of time, the protecting MOS transistor 31 is held in the ON state (conduction state). Thus, the high voltage generated in the power source wiring 11 is made to escape with the association of the channel current to the grounding wiring 12 and thus the internal circuit 20 is protected from the high voltage. It is noted that the given period of time described above is approximately determined based on a time constant obtained by multiplying the capacitance value of the capacitive element C by the resistance value of the resistive element R.

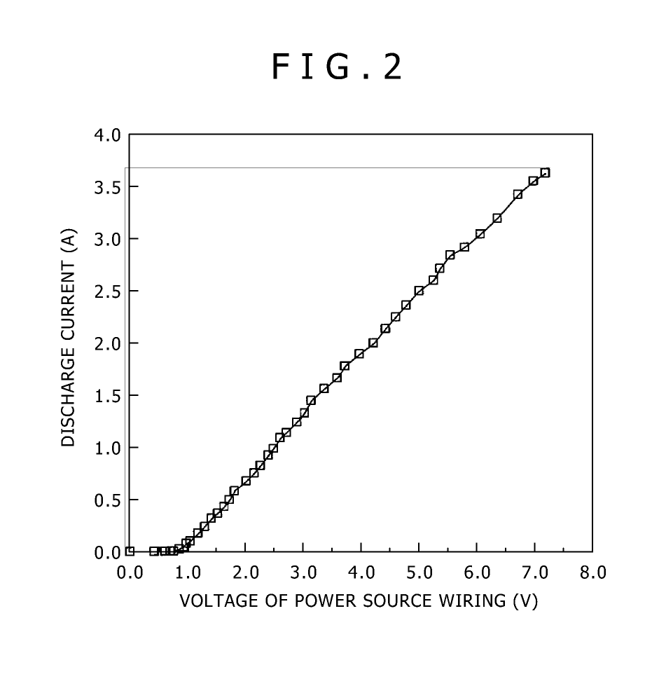

FIG. 2 shows an example of discharge current characteristics, of the ESD protecting circuit 30, which are obtained from a Transmission Line Pulse (TLP) device for applying a pulse-like surge. In FIG. 2, an axis of abscissa represents a crest value (a discrete value ranging from 0.0 V to 7.0 V) of a pulse voltage generated in the power source wiring 11, and an axis of ordinate represents a value of a discharge current caused to flow from the power source wiring 11 to the grounding wiring 12 of FIG. 1 at that time. In FIG. 2, a voltage (about 1.0 V) of the power source wiring at which the discharge current rises represents the voltage of the power source wiring 11 at which a state in which all of an amount of electric charges when the pulse is generated is consumed for the charge/discharge of the electric charges in/from the capacitive element C is changed to a state in which a part of the amount of electric charges starts to be caused to flow through the grounding wiring 12.

The time constant (R×C) (hereinafter spelled as “RC” as well) of the trigger circuit 33 of the RC triggered MOS is generally set to about 1 μs in many cases. The time constant (R×C) is set in consideration of the fact that a time for which the trigger circuit 33 is operated in a phase of the normal actuation of the power source does not become too long, and so forth. In order that the time constant R×C of 1 μs may be realized on the semiconductor substrate and the area of the element may be made smallest, it is efficient that an area of the resistive element R and an area of the capacitive element C are made approximately equal to each other. The reason for this is because the product of the areas of the resistive element R and the capacitive element C is approximately constant and it is most advantageous for reducing the sum of the areas of the two elements R and C to equalize the areas of the two elements R and C to each other. Specifically, when the resistive element R is made of polycrystalline silicon having a sheet resistance of 200Ω/□, and the capacitive element C is composed of a MIS (Metal Insulator Semiconductor) capacitor having a capacitance value of 4 fF/μm², the resistive element R is set to 250 kΩ from a size of 1 μm in width×1,000 μm in effective length, and the capacitive element C is set to 4 pF from an area of 1,000 μm² in effective area. As a result, the RC time constant of 250 kΩ×4 pF=1 μs is realized. Also, each of the occupied area of the resistive element R, and the occupied area of the capacitive element C becomes about 1,000 μm². It is noted that for the purpose of causing instantaneously a large current to flow, a large channel width is required for the protecting MOS transistor 31 and thus it is not rare that the channel width exceeds 1,000 μm. That is to say, the occupied area of the protecting MOS transistor 31 may become equal to several thousands of μm² similarly to the case of each of the resistive element R and the capacitive element C.

As can be seen from the above, since the trigger circuit 33 of the RC triggered MOS type ESD protecting circuit 30 occupies the area of several thousands μm² or more, reducing this area leads directly to the reduction of the cost.

The first embodiment of the present disclosure is such that the resistive element R and the capacitive element C of the trigger circuit 33 are integrated with each other, thereby reducing the occupied area of the trigger circuit 33 of the RC triggered MOS type ESD protecting circuit 30. Hereinafter, a configuration and the like for the RC integrated element 34 will be described in detail.

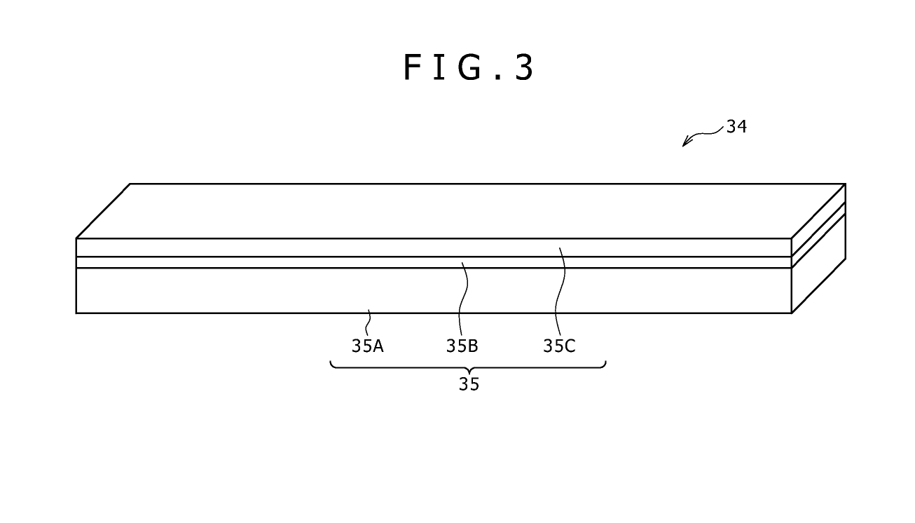

Specifically, as shown in FIG. 3, the trigger circuit 33 has the MIS capacitor 35 as the capacitive element C, and the resistive element R is composed of an upper element 35C of the MIS capacitor 35. As a result, in the ESD protecting circuit 30 and the semiconductor device 1 including the same, the occupied area of the trigger circuit 33 and thus the ESD protecting circuit 30 can be reduced.

The capacitive element C is a MIS capacitor 35 in which the upper electrode 35C is laminated on a lower electrode 35A composed of either a p-type well region or an n-type well region of a silicon (Si) substrate through a gate oxide film 35B. As has been described, the resistive element R is composed of the upper electrode 35C of the MIS capacitor 35. That is to say, the capacitive element C and the resistive element R are integrated into the MIS capacitor 35, thereby composing a capacitive element-resistive element integrated element (hereinafter referred to as “an RC integrated element”) 34.

The upper electrode 35C, for example, is made of either a metal or a semiconductor. In particular, the upper electrode 35C is preferably made of a semiconductor such as polycrystalline silicon, and is more preferably made of p-type polycrystalline silicon. The reason for this will be described later.

In addition, the upper electrode 35C is preferably made of p-type polycrystalline silicon without containing therein any of silicides for the purpose of suppressing the lowering of the resistance value.

The lower electrode 35A is preferably doped with an n-type impurity. The reason for this will be described later.

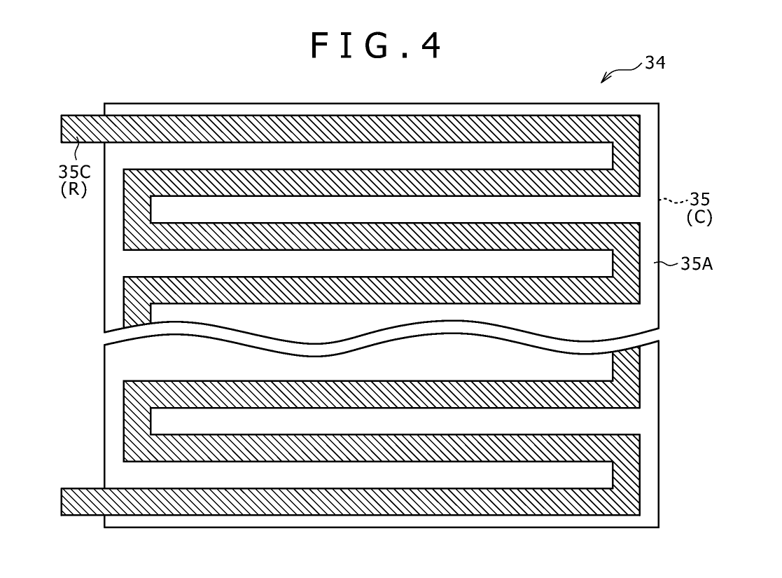

FIG. 4 is a top plan view showing a planar structure of the RC integrated element 34 shown in FIG. 3 when viewed from the upper electrode 35C (the resistive element R) side. The upper electrode 35C, for example, has two terminals (not shown), and a portion extending between the two terminals becomes the resistive element R. Preferably, the resistive element R is composed of a slender line-shaped body for the purpose of increasing the resistance value, and a planar shape thereof has a meandering shape in which a narrow line-shaped body is folded back.

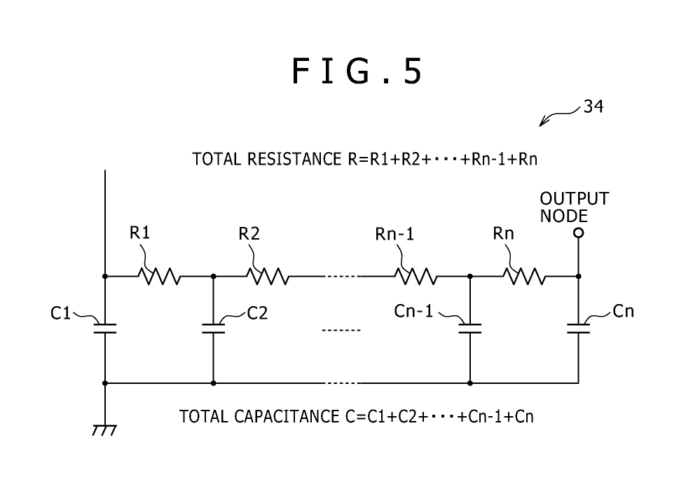

When the resistive element R and the capacitive element C are integrated with each other in such a manner, an equivalent circuit of the RC integrated element 34 is represented as shown in FIG. 5. Also, a substantial RC delay in an end portion (an output node in FIG. 5) of the RC integrated element 34 corresponds to (RC÷2) where R is a total resistance value of the upper electrode 35C, and C is a total capacitance value of the MIS capacitor portion 35.

Therefore, for example, for obtaining the same time constant of 1 μm as that exemplified in the above description, in a broad way, there is required RC which is about two times as large as that in the case where the resistive element R and the capacitive element C are formed separately from each other as described above. Therefore, when there are used the same numerical values as those in the assumption described above such that the sheet resistance of polycrystalline silicon composing the resistive element R of the RC integrated element is set to 250Ω/□, and the capacitance density of the capacitive element C is set to 4 fF/μm², the size is set to 1 μm in width, and the length is set to 1414 μm (≈1,000×√2). As a result, the resistance value of the upper electrode 35C of the RC integrated element 34 becomes about 354 kΩ, and the total capacitance value of the MIS capacitor 35 becomes 5.66 pF. Thus, the substantial RC delay becomes 354 kΩ×5.66 pF÷2=1 μs.

That is to say, when the resistive element R and the capacitive element C are formed separately from each other as described above, each of the resistive element R and the capacitive element C occupies the area of about 1,000 μm², and the total occupied area of the resistive element R and the capacitive element C becomes 2,000 μm². On the other hand, in the case of the RC integrated element 34, the occupied area can be suppressed to about 1,414 μm². Therefore, the resistive element R and the capacitive element C each having the large occupied area in the RC triggered MOS type ESD protecting circuit 30 can be realized with the smaller area (to about 1/√2-fold, that is, about 0.7-fold).

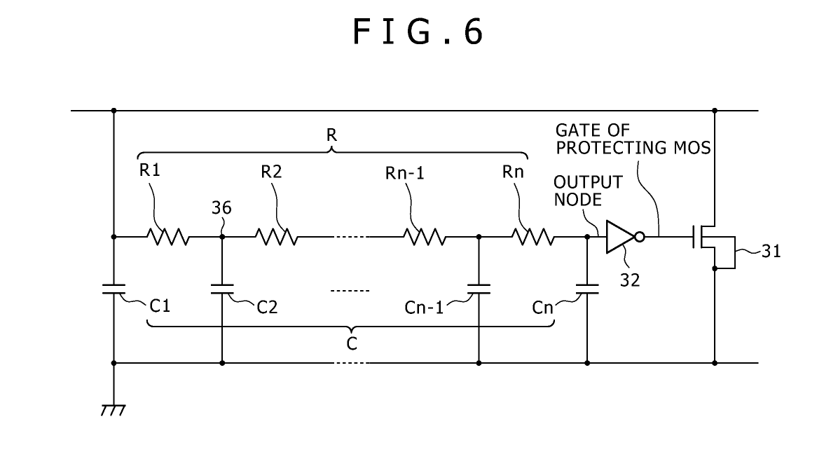

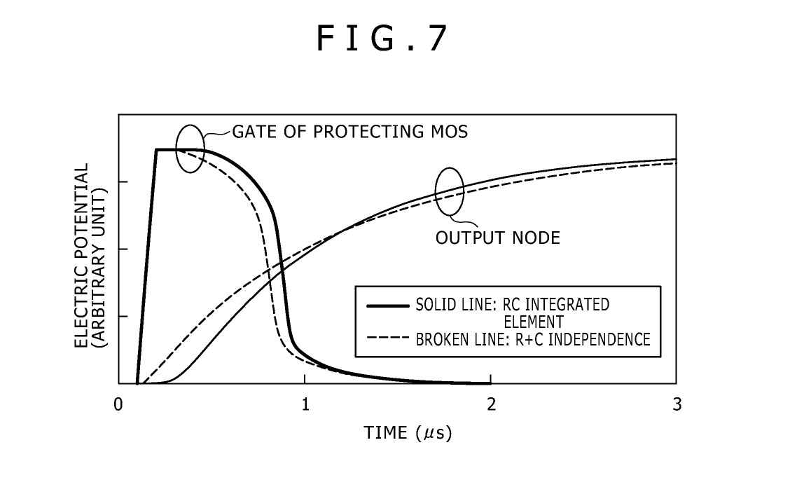

FIG. 7 is a graph representing an example in which an electric potential at the output node of the RC integrated element 34, and an electric potential at a gate terminal of the protecting MOS transistor 31 when by using the output node of the RC integrated element 34, the protecting MOS transistor 31 is driven via an inverter 32 as shown in FIG. 6 are individually, actually calculated. For the comparison, calculation results in the case of the existing configuration in which the resistive element R having the resistance value of 250 kΩ, and the capacitive element C having the capacitance value of 4 pF are provided separately from each other are also shown together with the case of the RC integrated element 34 in FIG. 7.

It is understood from FIG. 7 that the RC integrated element 34 in which the total resistance value is 354 kΩ, and the total capacitance value is 5.66 pF shows the transparent characteristics which are approximately equal to those in the existing configuration in which the resistive element R, and the capacitive element C are provided separately from each other. It is noted that, for example, as with the node shown by an intermediate electric potential 36 shown in FIG. 6, if the electric potential is taken out from the middle of the RC integrated element 34, it is possible to take out even a signal having the smaller RC delay. Thus, if another protecting MOS transistor is driven with an inversed signal of the signal having the smaller RC delay, then, it is also possible to shorter adjust a turn-ON time, that is, the discharge time.

For the purpose of utilizing the upper electrode 35C of the MIS capacitor 35 as the resistive element R, it is necessary to reduce a doping concentration for polycrystalline silicon composing the upper electrode 35C. In this case, however, in the case of the sheet resistance of about 250Ω/□ used as an example, it is possible to readily realize the reduction of the doping concentration for polycrystalline silicon composing the upper electrode 35C. Also, it is not difficult to further increase the resistance value by reducing the doping concentration. For example, when the sheet resistance of 250Ω/□ is realized with a polycrystalline silicon film having a thickness of 160 nm, a resistivity becomes 0.004 Ω·cm. When an impurity concentration is obtained in which the resistivity becomes 0.004 Ω·cm is obtained by using a relationship between the doping concentration and the resistivity in single crystal silicon as a guide, the impurity concentration of 10¹⁹ to 10²⁰/cm³ is obtained, and is a concentration which is readily realized. In addition, it is also precisely realize to further reduce the impurity concentration by about three digits. It is noted that since the relationship between the doping concentration and the resistivity in single crystal silicon is also influenced by the crystallinity and the heat history in the wafer process, the above estimation is merely a guide.

Here, an explanation will be given with respect to an influence exerted on the capacitance characteristics of the MIS capacitor 35 when the impurity concentration in the upper electrode 35C of the MIS capacitor 35 is reduced. In the RC-MOS structure shown in FIG. 5, it is only necessary to take only the case where the positive voltage is applied to the upper electrode 35C of the MIS capacitor 35, that is, only the case where the positive surge is applied to a Vcc pin into consideration. The reason for this is because the negative surge is made to escape through the diode. Therefore, in this case, if polycrystalline silicon composing the upper electrode 35C is made to be of a p-type, when the positive voltage is applied to the upper electrode 35C made of p-type polycrystalline silicon, there is obtained a state in which holes are accumulated in a region close to the gate oxide film 35B. Thus, even if the impurity concentration in polycrystalline silicon is low, the effective capacitance of the MIS capacitor 35 is not remarkably reduced. On the other hand, if polycrystalline silicon composing the upper electrode 35C is made to be of an n-type, when the positive voltage is applied to the upper electrode 35C made of n-type polycrystalline silicon, a depletion layer spreads to the region, close to the gate oxide film 35B, of n-type polycrystalline silicon, so that a depletion layer capacitor comes to be connected in series with a capacitor composed of the gate oxide film 35B. As a result, the effective capacitance of the MIS capacitor is reduced to reduce the effective RC. Thus, for the purpose of realizing the same RC value, the RC integrated element 34 having the larger area is required. Therefore, the upper electrode 35C of the MIS capacitor 35 is preferably made of p-type polycrystalline silicon.

The semiconductor device 1, for example, can be manufactured in the following manner.

What is kept in mind as an object of the present disclosure is a so-called MOS process which is popular in manufacturing a Large Scale Integrated Circuit (LSI) on a Si substrate. Thus, there is not especially a limit to the technique and the minimum processing size of the generation. Thus, the present disclosure, for example, targets at the processes from the 0.18-μm process up to the 45-nm or less newest process. Although reference is not made to the details of the process because the effectiveness of the present disclosure does not depend on the manufacture process, the outline will be described below.

A MOS transistor is formed on a well region formed in a Si substrate. Although Shallow Trench Isolation (STI) is generally adopted as isolation, the present disclosure is by no means limited thereto. A gate oxide film is composed of a so-called high-k (high-dielectric constant) gate insulating film containing therein SiO₂, SiON or a metallic oxide. In general, gate insulating films having plural levels, respectively, are prepared on the same substrate. Thus, in general, a thin gate insulating film is used in an area of a high-speed logic circuit portion or a Static Random Access Memory (SRAM), and a thick gate insulating film is used in an input/output circuit portion or an analog circuit portion. When in the advanced process, a high-k gate insulating film is applied, in general, the thick gate insulating film adopts a structure in which a high-k gate insulating film is laminated on a SiO₂ film. Polycrystalline silicon or a metal is used as a gate electrode material. A silicide layer containing therein cobalt, nickel or the like is formed on a surface area of a source or drain region of the MOS transistor, thereby contributing to the lowering of a resistance value in many cases. When an upper layer portion of the gate electrode is made of polycrystalline silicon, the silicide layer containing therein cobalt, nickel or the like is formed on the upper layer portion as well of the gate electrode.

In such a MOS process technology, in addition to the MOS transistor as a main constituent element, a resistive element and a capacitive element are both required in many cases, and are provided either as standard elements or as option elements. The resistive element, for example, can be obtained by forming a slender polycrystalline silicon film on an isolation insulating film. Also, the capacitive element is simply realized by removing away both of a source region and a drain region from the MOS transistor. A device such that for the purpose of preventing the capacitance from being largely changed depending on the gate voltage, the silicon substrate region as the lower electrode is more heavily doped with an impurity than each of the well region and the channel of the MOS transistor is carried out in some cases. In the case of the MOS process in which plural thickness levels are prepared for the gate insulating film, in general, for the purpose of suppressing a leakage current from the gate insulating film, a thick film thickness is applied to the gate insulating film of the MIS capacitor becoming the capacitive element.

Processes for manufacturing the RC integrated element 34 in the first embodiment will now be described with the MOS process as described above being kept in mind.

For example, the MIS capacitor 35 as shown in FIG. 3 is formed as the capacitive element C and the polycrystalline silicon layer composing the upper electrode 35C of the MIS capacitor 35 is used as the resistive element R, thereby making it possible to form the RC integrated element 34.

Here, in the MOS process technology described above, the silicide layer containing therein cobalt, nickel or the like is formed on the surfaces of the source and drain regions of the MOS transistor, the upper layer portion of the gate electrode of the MOS transistor, and the like, so that the silicide layer contributes to the lowering of the resistance value. However, with regard to the polycrystalline silicon layer of the upper electrode 35C coming to compose the resistive element R, it is not preferable to form the silicon layer. Therefore, in the process for forming the MOS transistor by using the MOS process technology described above, a silicide inhibiting film (not shown) or the like is preferably formed by using the known technique so as to prevent the silicide layer from being formed on a region in which the RC integrated element 34 is intended to be formed.

The impurity conductivity type in the phase of the doping to the lower electrode 35A of the MIS capacitor 35 is preferably made an n-type in order to increase the capacitance when the positive bias is applied to the gate electrode. However, as long as the lower electrode 35A of the MIS capacitor 35 is more heavily doped than each of the normal well region and channel region, even when the impurity conductivity type in the phase of the doping to the lower electrode 35A of the MIS capacitor 35 is made a p-type, the loss in the capacitance does not become large. When the heavy doping is carried out by using the n-type impurity, it is possible to obtain the largest electrical capacitance. However, in the process for carrying out the gate oxidation after completion of the doping, when the impurity concentration in the lower electrode 35A is too high, since enhanced oxidation is caused in a phase of the gate oxidation, the thickness is increased. As a result, contrary, since the capacitance value is reduced, there is a limit to a doping concentration in the lower electrode 35A.

When polycrystalline silicon is used for the upper electrode 35C, the impurity conductivity type in the phase of the doping to the upper electrode 35C of the MIS capacitor 35 is preferably made a p-type so as to increase the capacitance when the positive bias is applied to the gate electrode. In the first embodiment of the present disclosure, since polycrystalline silicon is utilized for the resistive element R as well, the doping concentration has to be set lower than gate polycrystalline silicon of the normal MIS element. Thus, in the case of the n-type doping, since the capacitance loss due to gate depletion is not disregarded, the impurity conductivity type has to be of the p-type.

When the MOS process such that a metallic gate electrode is used as the gate electrode of a MOSFET (Metal Oxide Semiconductor Field Effect Transistor) as the main constituent element is applied, the metallic gate electrode may be used as the upper electrode 35C. When the resistance value is desired to be further increased, a manufacturing process may be added, the metallic gate electrode of the MIS portion acting as the RC integrated electrode 34 may be removed, and p-type polycrystalline silicon may be formed instead.

As described above, in the first embodiment of the present disclosure, in the trigger circuit 33, the MIS capacitor 35 is provided as the capacitive element C, and the resistive element R is composed of the upper electrode 35C of the MIS capacitor 35. Therefore, it is possible to reduce the total occupied area of the capacitive element C and the resistive element R to about 1/√2 tims, that is, about 0.7 times less than that in the case where the capacitive element C and the resistive element R are provided separately from each other as with the related art.

### 2. Second Embodiment

The ESD protecting circuit 30 according to a second embodiment of the present disclosure includes the trigger circuit 33 and the protecting MOS transistor 31 as previously described. In this case, the trigger circuit 33 includes the capacitive element C and the resistive element R and is connected between the two power source lines: the power source wiring 11; and the grounding wiring 12. Also, the protecting MOS transistor 31 is connected in parallel with the trigger circuit 33 and has the control electrode connected to the output terminal of the trigger circuit 33. In addition, the trigger circuit 33 has the MIS capacitor 35 as the capacitive element C, and the resistive element R is composed of the upper electrode 35C of the MIS capacitor 35.

Although the present disclosure has been described so far by giving the embodiments, the present disclosure is by no means limited thereto, and thus various kinds of changes thereof can be made. For example, although in the first embodiment, the description has been given with respect to the case where in the trigger circuit 33, the resistive element R and the capacitive element C are connected to the power source line 11 side and the grounding wiring 12 side, respectively, it is also possible to adopt a configuration in which the capacitive element C and the resistive element R are connected to the power source line 11 side and the grounding wiring 12 side, respectively.

For example, although in the first embodiment described above, the description has been given by concretely giving the configuration and the like of the semiconductor device 1, the semiconductor device 1 does not have to include all of the constituent elements and the semiconductor device 1 may also include other suitable constituent elements.

It is noted that the present disclosure can also adopt the following constitutions.

(1) An ESD protecting circuit including:

a trigger circuit having a capacitive element and a resistive element and connected between two power source lines; and

a protecting transistor connected in parallel with the trigger circuit and having a control electrode connected to an output terminal of the trigger circuit,

in which the trigger circuit has an MIS capacitor as the capacitive element, and the resistive element is composed of an upper electrode of the MIS capacitor.

(2) The ESD protecting circuit described in the paragraph (1), in which the upper electrode is made of a semiconductor.

(3) The ESD protecting circuit described in the paragraph (2), in which the upper electrode is made of p-type silicon.

(4) The ESD protecting circuit described in the paragraph (3), in which the upper electrode is made of p-type silicon without containing a silicide in the upper electrode.

(5) The ESD protecting circuit described in any one of the paragraphs (1) to (4), in which a lower electrode of the MIS capacitor is doped with a n-type impurity.

(6) The ESD protecting circuit described in any one of the paragraphs (1) to (5), in which the upper electrode has two terminals, and a portion between the two terminals becomes the resistive element.

(7) The ESD protecting circuit described in the paragraph (6), in which a planar shape of the resistive element is a meandering shape.

(8) A semiconductor device, including:

an ESD protecting circuit protecting an internal circuit connected between two power source lines,

in which the ESD protecting circuit includes
a trigger circuit having a capacitive element and a resistive element and connected between the two power source lines, and
a protecting transistor connected in parallel with the trigger circuit and having a control electrode connected to an output terminal of the trigger circuit,
the trigger circuit having an MIS capacitor as the capacitive element, and
the resistive element being composed of an upper electrode of the MIS capacitor.

The present disclosure contains subject matter related to that disclosed in Japanese Priority Patent Application JP 2011-267545 filed in the Japan Patent Office on Dec. 7, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electrostatic discharge protecting circuit, comprising:
a trigger circuit including a capacitive element and a resistive element and connected between two power source lines; and
a protecting transistor connected in parallel with said trigger circuit and having a control electrode connected to an output terminal of said trigger circuit,
wherein said trigger circuit has an MIS capacitor as said capacitive element, and said resistive element is composed of an upper electrode of said MIS capacitor.

2. The electrostatic discharge protecting circuit according to claim 1, wherein said upper electrode is made of a semiconductor.

3. The electrostatic discharge protecting circuit according to claim 2, wherein said upper electrode is made of p-type silicon.

4. The electrostatic discharge protecting circuit according to claim 3, wherein said upper electrode is made of p-type silicon without containing a silicide in said upper electrode.

5. The electrostatic discharge protecting circuit according to claim 1, wherein a lower electrode of said MIS capacitor is doped with a n-type impurity.

6. The electrostatic discharge protecting circuit according to claim 1, wherein said upper electrode has two terminals, and a portion between said two terminals becomes said resistive element.

7. The electrostatic discharge protecting circuit according to claim 6, wherein a planar shape of said resistive element is a meandering shape.

8. A semiconductor device, comprising:
an electrostatic discharge protecting circuit protecting an internal circuit connected between two power source lines,
wherein said electrostatic discharge protecting circuit includes
a trigger circuit having a capacitive element and a resistive element and connected between said two power source lines, and
a protecting transistor connected in parallel with said trigger circuit and having a control electrode connected to an output terminal of said trigger circuit,
said trigger circuit having an MIS capacitor as said capacitive element, and
said resistive element being composed of an upper electrode of said MIS capacitor.
